(19) United States
(12) Patent Application Publication
(10) Pub. No.: US 2014/0101320 A1
(43) Pub. Date: Apr. 10, 2014

(54) INFORMATION PROCESSING SYSTEM, CONTROL METHOD, MANAGEMENT APPARATUS AND COMPUTER-READABLE RECORDING MEDIUM

(71) Applicant: FUJITSU LIMITED, Kawasaki-shi (JP)

(72) Inventors: TOMOTAKA ENDO, Yokohama (JP); YU MINAKUCHI, Yokohama (JP); MASAHIKO OHASHI, Nagoya (JP)

(73) Assignee: FUJITSU LIMITED, Kawasaki-shi (JP)

(21) Appl. No.: 14/105,161

(22) Filed: Dec. 12, 2013

Related U.S. Application Data
(63) Continuation of application No. PCT/JP2011/064585, filed on Jun. 24, 2011.

(51) Int. Cl. H04L 12/911

(52) U.S. Cl. CPC H04L 47/78
USPC 709/226

(57) ABSTRACT

A management apparatus of a sub-system receives, from a main system, management information including information about each resource of processor resource, storage resource, network resource, which are used by a user with the main system. The management apparatus of the sub-system reserves, in the sub-system, the storage resource for storing data of the user held by the main system and the minimum network resource for receiving the data, on the basis of the management information received. The management apparatus of the sub-system uses the reserved network resource to receive the data from the main system, and stores the data to the reserved storage resource. The management apparatus of the sub-system reserves, in the sub-system, the network resource and the processor resource used by the user with the main system, on the basis of the received management information when the user is allowed to use the second system.

### CROSS-REFERENCE TO RELATED APPLICATION

This application is a continuation application of International Application PCT/JP2011/064585, filed on Jun. 24, 2011, and designating the U.S., the entire contents of which are incorporated herein by reference.

### FIELD

The embodiments discussed herein are related to an information processing system, a control method of an information processing system, a management apparatus, and a system switching program.

### BACKGROUND

In the past, data and system configurations are backed up at a remote location and the like to prepare for failure and disaster. In general, as a stand by system, a stand by system is constructed that reserves resources equivalent to each of a CPU (Central Processing Unit) resource, a storage resource, and a network resource of a main system that operates in normal state. Data to be held by the main system are also backed up to a medium and the like with a regular interval.

When the main system becomes unavailable due to failure and the like, the data of the main system are copied to the stand by system, and the stand by system is caused to operate as a new main system. Even when services cannot be provided by the main system, the services are continuously provided by the stand by system in this manner.
Patent Literature 1: Japanese Laid-open Patent Publication No. 06-259271
Patent Literature 2: Japanese Laid-open Patent Publication No. 2000-207374

With the conventional techniques, however, the stand by system is prepared that reserves at least the resources equivalent to the main system in normal state in which no failure occurs, and therefore, there is a problem in that the cost of redundancy of the system is high.

For example, even when a backup system of a cloud system A used by users is constructed, another cloud system B is constructed that reserves at least the resources used by the users with the cloud system A. The cloud system B which is the stand by system for the cloud system A not only reserves the resources of the cloud system A as the stand by system for the cloud system A but also provides the resources to other users. For this reason, when the cloud system A fails, the cloud system B has to stop providing the resources to other users and has to reserve the resources of the cloud system A, and therefore, the efficiency of use of the entire cloud system is low, and this can hardly be said to be an efficient backup method.

### SUMMARY

According to an aspect of an embodiment, an information processing system includes a first system and a second system each having a management apparatus, wherein the management apparatus of the first system includes: a first memory; and a first processor coupled to the first memory, wherein the first processor executes a process including: collecting processor resource, storage resource, network resource used by a user with the first system; and transmitting management information including information each resource collected at the collecting to the second system, and the management apparatus of the second system includes: a second memory; and a second processor coupled to the second memory, wherein the second processor executes a process including: receiving the management information from the first system; first reserving, in the second system, storage resource for storing data of the user held by the first system and a minimum network resource for receiving the data, on the basis of the management information; receiving the data from the first system using the network resource reserved at the first reserving, and storing the data to the storage resource reserved at the first reserving; and second reserving, in the second system, the network resource and the processor resource collected by the management apparatus of the first system, on the basis of the received management information when the user is allowed to use the second system.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a figure illustrating an entire configuration example of a system according to a first embodiment.

FIG. 2 is a functional block diagram illustrating a configuration of a cloud cooperation server according to the first embodiment.

FIG. 3 is a figure illustrating an example of information stored in a resource information DB.

FIG. 4 is a figure illustrating an example of information stored in a management information table.

FIG. 5 is a figure illustrating an example of information stored in a cooperation information table.

FIG. 6 is a functional block diagram illustrating a configuration of a storage management server according to the first embodiment.

FIG. 7 is a figure illustrating an example of information stored in a storage resource information DB.

FIG. 8 is a functional block diagram illustrating a configuration of a network management server according to the first embodiment.

FIG. 9 is a figure illustrating an example of information stored in the network resource information DB.

FIG. 10 is a sequence diagram illustrating a flow of processing according to the first embodiment.

FIG. 11 is a sequence diagram illustrating a flow of processing according to the first embodiment.

FIG. 12 is a figure illustrating an entire configuration example of a system according to a second embodiment.

FIG. 13 is a flowchart illustrating data backup executed by a cloud system (sub-system) according to the second embodiment.

FIG. 14 is a flowchart illustrating system switching executed by a cloud system (sub-system) according to the second embodiment.

FIG. 15 is a figure illustrating an example of hardware configuration of a computer executing a system switching program.

### DESCRIPTION OF EMBODIMENTS

Preferred embodiments will be explained with reference to accompanying drawings. It is to be noted that the invention is not limited by the embodiments.

### [a] First Embodiment

Entire Configuration

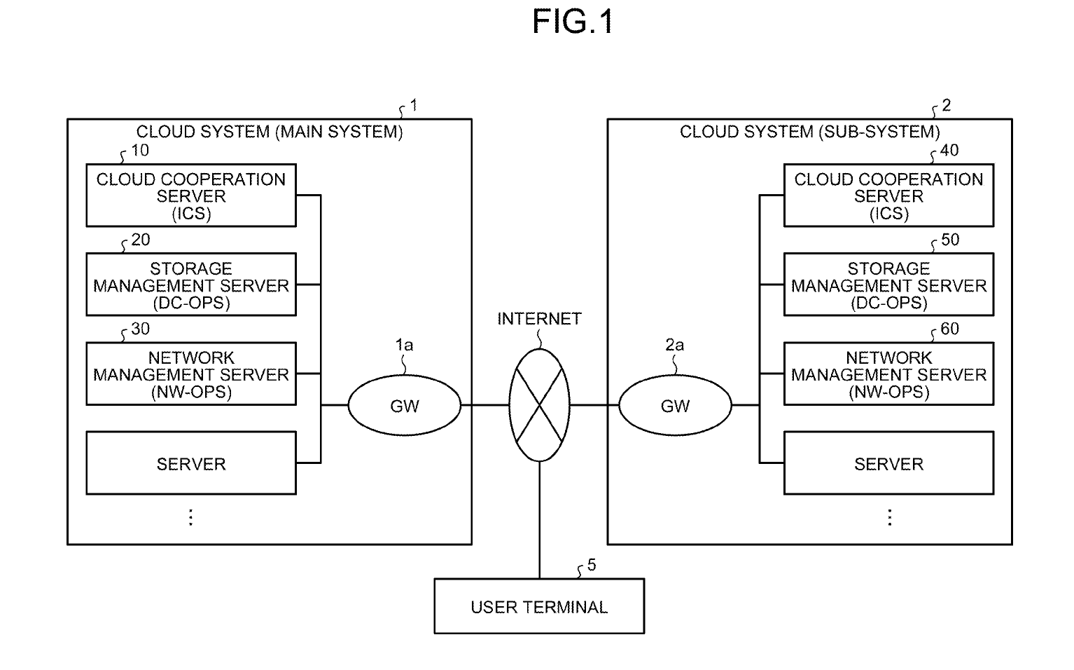

FIG. 1 is a figure illustrating an entire configuration example of a system according to the first embodiment. As illustrated in FIG. 1, this system includes a cloud system 1, a cloud system 2, and a user terminal 5, and the systems and each system and the user terminal 5 are connected via a network such as the Internet. The user terminal 5 is a user terminal using the cloud system 1.

The cloud system 1 is a system used by a user of the user terminal 5. This cloud system 1 includes a gateway apparatus (GW) 1a and a cloud cooperation server (ICS: Inter Cloud Server) 10. This cloud system 1 includes a storage management server (DC-OPS: Data Center Operation System) 20, a network management server (NW-OPS: Network Operation System) 30, and another server.

The gateway apparatus 1a is a network device for controlling communication between the cloud system 1 and another cloud system or the user terminal 5. The ICS 10 is a server apparatus receiving instructions of, e.g., system switching from the user terminal 5 and carrying out various kinds of control. The ICS 10 manages processor resource, storage resource, network resource used by a user with the cloud system 1. For example, the ICS 10 performs management by collecting processor resource, storage resource from the DC-OPS 20 and collecting network resource from the NW-OPS 30.

The DC-OPS 20 is a server apparatus for centrally managing the storage resource and the processor resource used by the user with the cloud system 1. For example, the DC-OPS 20 collects, e.g., the amount of data and the number of processors used by the user from each server in the cloud system 1. The NW-OPS 30 is a server apparatus for centrally managing the network resource used by the user with the cloud system 1. For example, the NW-OPS 30 collects, e.g., band width allocated to users and the form of the network used by users from each server in the cloud system 1. Various kinds of servers (which are expressed as other servers in the above explanation) are server apparatuses used by users such as a Web server and a DB (DataBase) server.

The cloud system 2 is a system used by users other than the user terminal 5. The cloud system 2 has a gateway apparatus (GW) 2a, a cloud cooperation server (ICS) 40, a storage management server (DC-OPS) 50, a network management server (NW-OPS) 60, and other servers. Each apparatus provided in the cloud system 2 executes the same function as the apparatuses provided in the cloud system 1, and therefore, detailed explanation thereabout is omitted.

Hereinafter explained is an example where the backup system of the cloud system 1 is delegated to the cloud system 2 in such state. More specifically, hereinafter explained is an example where the cloud system 1 operates as a main system, and the cloud system 2 operates as a sub-system system.

The ICS 10 of the cloud system 1 collects processor resource, storage resource, and network resource used by users with the cloud system 1, and transmits management information including information about various kinds of resources thus collected to the cloud system 2.

The ICS 40 of the cloud system 2 receives the management information from the cloud system 1. Then, the ICS 40 reserves, in the cloud system 2, the storage resource for storing data of the user held by the cloud system 1 and the minimum network resource for receiving the data on the basis of the received management information. Subsequently, the ICS 40 receives data from the cloud system 1 using the reserved network resources, and stores the data to the minimum storage resource reserved. Thereafter, in a case where the user uses the cloud system 2, and more specifically, when system switching is executed, the ICS 40 reserves, in the cloud system 2, the network resource and the processor resource collected by the ICS 10, on the basis of the received management information.

As described above, the cloud system serving as the sub-system reserves only the resources for the backup in normal circumstances, on the basis of the management information received from the main system. Then, in system switching, the cloud system serving as the sub-system reserves the resources equivalent to the main system on the basis of the management information. More specifically, even if the backup system, the sub-system does not always the system resources equivalent to the main system for the main system, and in normal circumstances, the resources are provided to other users, and only the resources for the data backup for the main system are reserved. Then, when system switching occurs, the sub-system reserves the resources equivalent to the main system. Therefore, the services can be continued while reducing the cost for redundancy of the system.

Configuration of Apparatus

Subsequently, the configuration of each apparatus provided in the cloud system explained in FIG. 1 will be explained. In FIG. 1, for example, the cloud system 1 is the main system, and the cloud system 2 is the sub-system, but the present invention is not limited thereto. For example, the cloud system 1 is the main system in the relationship with the cloud system 2. Alternatively, the cloud system 1 may be the sub-system in the relationship with a cloud system 3, not illustrated. Likewise, the cloud system 2 is the sub-system in the relationship with the cloud system 1. Alternatively, the cloud system 2 may be the main system in the relationship with a cloud system 4, not illustrated.

More specifically, the cloud cooperation server 10, the storage management server 20, and the network management server 30 of the cloud system 1 have the same control units as the cloud cooperation server 40, the storage management server 50, and the network management server 60 of the cloud system 2, respectively. For this reason, in this case, the cloud cooperation server 10, the storage management server 20, and the network management server 30 will be explained. The cloud system 1 may have only the processing unit serving as the main system, and the cloud system 2 may have only the processing unit serving as the sub-system.

Configuration of Cloud Cooperation Server

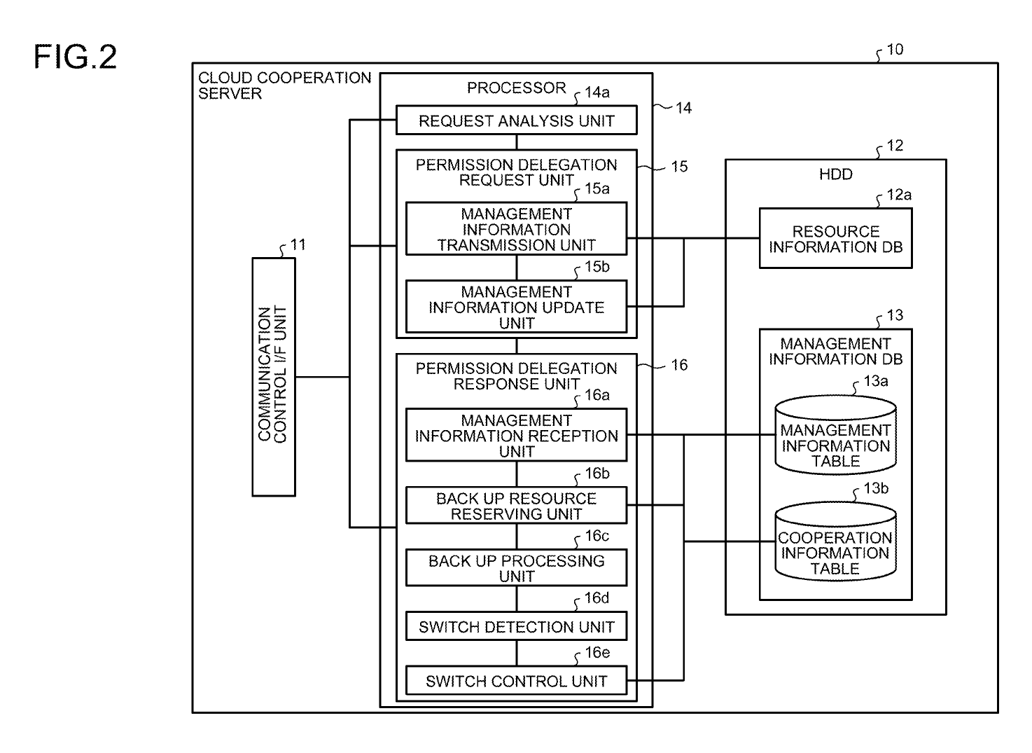

FIG. 2 is a functional block diagram illustrating a configuration of a cloud cooperation server according to the first embodiment. As illustrated in FIG. 2, the cloud cooperation server 10 includes a communication control interface unit (I/F unit) 11, an HDD (Hard Disk Drive) 12, and a processor 14.

The communication control I/F unit 11 is an interface for controlling communication with another apparatus and system. For example, the communication control I/F unit 11 obtains the storage resource and the processor resource from the storage management server 20 in the cloud system 1, and obtains the network resource from the network management server 30. The communication control I/F unit 11 receives the management information from another cloud system.

The communication control I/F unit 11 transmits a resource freeing request to the storage management server 20 and the network management server 30, and receives response in reply to the resource freeing request from each management server. The communication control I/F unit 11 receives various kinds of instructions transmitted from the user terminal 5.

The HDD 12 stores programs and the like executed by the processor 14, and includes a work region and the like temporarily storing data and the like when each processing unit of the processor 14 executes processing. This HDD 12 includes a resource information DB 12a and a management information DB 13.

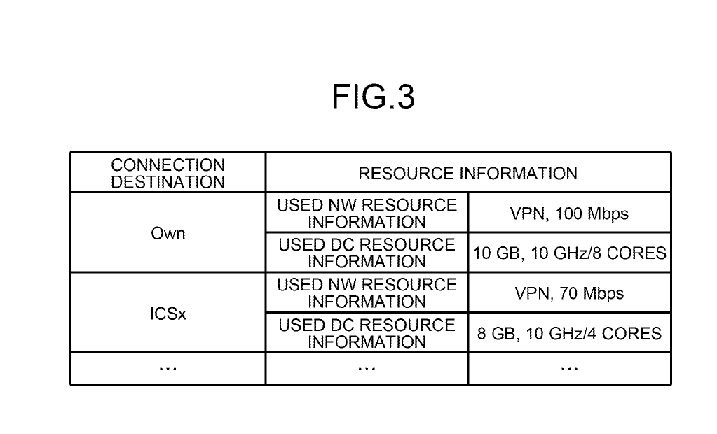

The resource information DB 12a is a database storing processor resource, storage resource, network resource used by users with the cloud system 1. FIG. 3 is a figure illustrating an example of information stored in a resource information DB. As illustrated in FIG. 3, the resource information DB 12a stores “connection destination, resource information (used NW resource information, used DC resource information)” in association with each other.

The “connection destination” stored here indicates an identifier identifying a user using a resource. The “used NW resource information” is information indicating the network resource used by the user, and is, for example, the type of circuit, band width, and the like used by the user. The “used DC resource information” is information indicating storage resource and processor resource used by the user, and is, for example, the storage capacity used by the user, the number of cores of the CPU (Central Processing Unit), and the performance.

In the case of FIG. 3, the owner user of the cloud system 1 “Own” is using VPN (Virtual Private Network) as a network, and 100 Mbps. This also indicates that “Own” is using 10 GB as the storage capacity and eight CPUs of 10 GHz. Likewise, this indicates that a user other than the owner user of the cloud system 1 “ICSx” is using VPN (Virtual Private Network) as a network, and 70 Mbps. This also indicates that “ICSx” is using 8 GB as the storage capacity and four CPUs of 10 GHz.

The management information DB 13 is a database storing the management information received from the cloud system using the cloud system 1 as the sub-system, i.e., the main system cloud system, and includes a management information table 13a and a cooperation information table 13b.

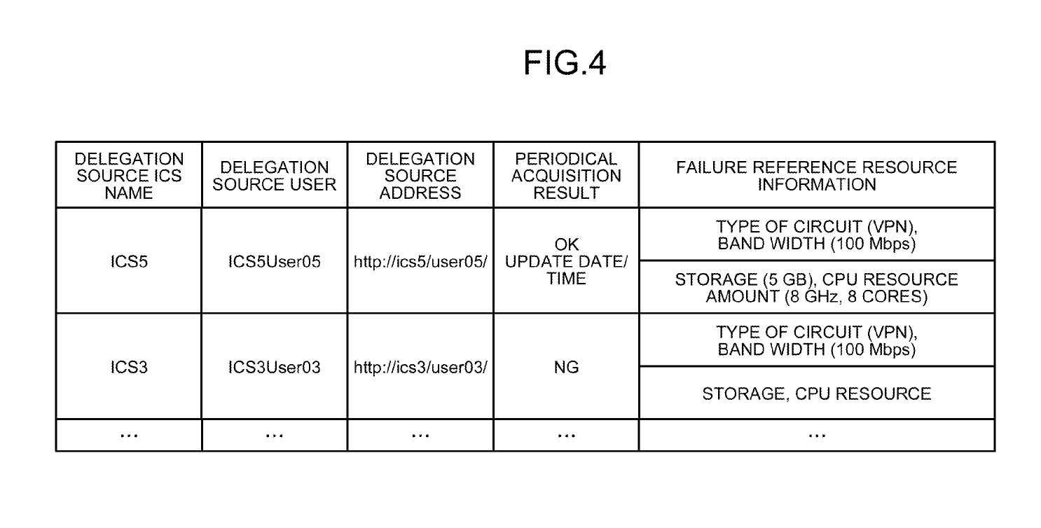

The management information table 13a stores the management information about the source of delegation of the management information. More specifically, the management information table 13a stores the resource information transmitted from the main system cloud system which uses the cloud system 1 as the sub-system. FIG. 4 is a figure illustrating an example of information stored in the management information table. As illustrated in FIG. 4, the management information table 13a stores “delegation source ICS name, delegation source user, delegation source address, periodical acquisition result, failure reference resource information” in association with each other.

The “delegation source ICS name” stored here is the ICS name of the delegation source of the management information, i.e., the identifier of the cloud cooperation server of the main system cloud system. The “delegation source user” is the identifier of the user using the delegation source ICS name. The “delegation source address” is address information about the cloud system of the delegation source, for example, URL (Uniform Resource Locator). The “periodical acquisition result” indicates whether the management information can be obtained from the delegation source with a regular interval, and the latest acquisition date/time, and when, for example, it can be obtained with a regular interval, “OK” is stored thereto, and when it cannot be obtained with a regular interval, “NG” is stored thereto. The “failure reference resource information” indicates the type of circuit and the band width used by the delegation source user. The information stored here is extracted from management information received from another ICS.

In the case of FIG. 4, this indicates that the management information of the user “ICS5User05” using the ICS 5 of “http://ics5/user05/” is obtained with a regular interval. This indicates that the following information is extracted from the obtained management information: “the type of circuit being used by the user 05 of the ICS 5 is VPN, and the band width is 100 Mbps”, and “the storage being used by the user 05 of the ICS 5 is 5 GB, and the CPU resource is 8 GHz, 8 cores”. In the case of FIG. 4, the ICS 5 and the ICS 3 are stored as the delegation source ICS names, and therefore, the cloud system 1 is the sub-system of the two cloud systems.

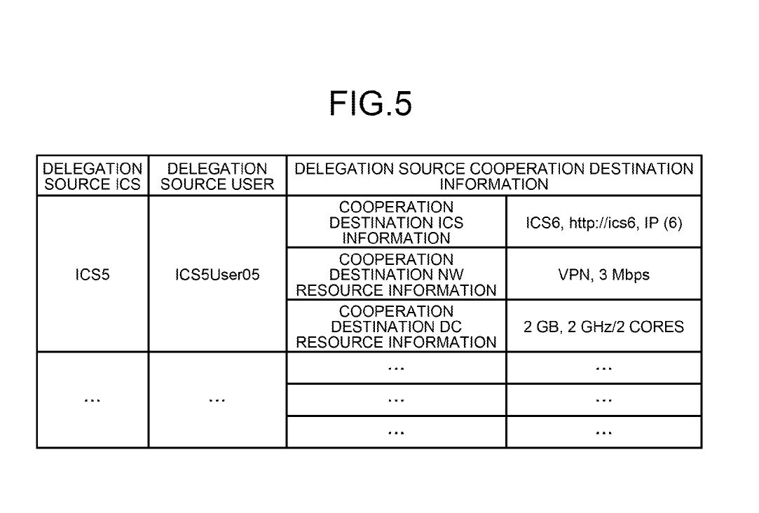

The cooperation information table 13b stores information received together with the management information of the delegation source when the delegation source cooperates with another cloud system to use its resources. More specifically, the cooperation information table 13b stores the contents of the cooperation destination when services are provided to users by causing the cloud system of the delegation source cooperates with another cloud system. Even when, as a result, system switching occurs, the services can be continued without breaking cooperation relationship. FIG. 5 is a figure illustrating an example of information stored in a cooperation information table. As illustrated in FIG. 5, the cooperation information table 13b stores “delegation source ICS, delegation source user, delegation source cooperation destination information (cooperation destination ICS information, cooperation destination NW resource information, cooperation destination DC resource information)” in association with each other.

The “delegation source ICS” stored here is the ICS name of the delegation source cooperating with another cloud, i.e., the identifier of the cloud cooperation server of the main system cloud system. The “delegation source user” is the identifier of the user using the delegation source ICS name cooperating with another cloud. The “cooperation destination ICS information” indicates information about another ICS to which the delegation source user is cooperating with, for example, the connection point and the ICS of the cooperation destination. The “cooperation destination NW resource information” indicates network resource under another ICS with which the delegation source user is cooperating, for example, the type of circuit, the band width, and the connection point. The “cooperation destination DC resource information” indicates storage resource or processor resource under another ICS with which the delegation source user is cooperating, for example, the used storage, the amount of resource of CPU, and the connection point.

In the case of FIG. 5, this indicates that the user 05 of the ICS 5 is cooperating using the apparatus having IP (Internet Protocol) 6 under the ICS 6 of “http://ics6” as the connection point. This indicates that the user 05 of the ICS 5 is using 3 Mbps VPN circuit as the network resource with the ICS 6. This indicates that the user 05 of the ICS 5 is using the storage capacity of 2 GB as the storage resource and using two 2 GHz CPUs as the processor resource with the ICS 6.

Back to the explanation about FIG. 2, the processor 14 is an electronic circuit such as a CPU centrally controlling the cloud cooperation server 10, and includes a request analysis unit 14a, a permission delegation request unit 15, and a permission delegation response unit 16. The processor 14 may include a CPU and a storage device (RAM, cache, and the like) storing programs achieving each function and storing data for processing.

The request analysis unit 14a is a processing unit for receiving various kinds of requests from the user terminal 5 and executing analysis. For example, the request analysis unit 14a analyzes, from, e.g., the contents of the payload of the received request, as to whether the request received from the user terminal 5 is a transmission request of management information, setting or change of transmission interval of the management information, or execution request of system switching. Then, when the request is transmission request of the management information or setting or change of the transmission interval of the management information, the request analysis unit 14a outputs the received contents to the permission delegation request unit 15. When the request is execution request of system switching, the request analysis unit 14a outputs to the permission delegation response unit 16.

The permission delegation request unit 15 is a processing unit for executing functions as the main system cloud system, and includes a management information transmission unit 15a and a management information update unit 15b. When the management information transmission unit 15a receives the transmission interval of the management information from the request analysis unit 14a and the like, and the transmission time has arrived, the management information transmission unit 15a adjusts “resource information (used NW resource information, used DC resource information)” stored in the resource information DB 12a, and transmits it as the management information to the ICS of the sub-system.

For example, with 10 minute interval, the management information transmission unit 15a of the cloud system 1 transmits the resource information of “Own” and the resource information of “ICSx” stored in the resource information DB 12a as the management information to the ICS 40 of the cloud system 2. The ICS of the transmission destination can be set and changed in any way by the user. The management information transmission unit 15a transmits the location, address information, and the like of the user who uses the resources identified by the management information as well as the management information. Further, when the cloud system is cooperating with another cloud system, the management information transmission unit 15a also transmits the cooperation information.

The management information update unit 15b is a processing unit for updating the resource information stored in the resource information DB 12a. For example, the management information update unit 15b transmits, with a regular interval, the acquisition request of the resource information used to the storage management server 20 and the network management server 30. Then, when the management information update unit 15b receives the response of the acquisition request, the management information update unit 15b extracts the resource information from the response received. Then, the management information update unit 15b updates the resource information stored in the resource information DB 12a with the extracted resource information. The management information update unit 15b receives cooperation information from users and administrators, and stores the cooperation information to the HDD 12 and the like.

The permission delegation response unit 16 is a processing unit executing the functions as the sub-system cloud system, and includes a management information reception unit 16a, a backup resource reserving unit 16b, a backup processing unit 16c, a switch detection unit 16d, and a switch control unit 16e.

The management information reception unit 16a is a processing unit receiving, with a regular interval, the management information and the cooperation information from the main system cloud system. For example, the management information reception unit 16a extracts “delegation source ICS name, delegation source user, delegation source address” from the management information received from the main system cloud system, stores the “delegation source ICS name, delegation source user, delegation source address” to the management information table 13a. The management information reception unit 16a extracts the “resource information” from the management information received from the main system cloud system, and stores the “resource information” as the “failure reference resource information” to the management information table 13a. The management information reception unit 16a stores the location, address information, and the like of the user extracted from the management information to the “delegation source address” and the like.

When the management information reception unit 16a can receive the management information with a regular interval, “OK” is stored to the “periodical acquisition result” of the management information table 13a, and “the reception time of the management information” is stored to the “update time”. On the other hand, when the management information reception unit 16a receives the management information, “NG” stores the “periodical acquisition result” of the management information table 13a, and “-” is stored to the “update time”. When the management information reception unit 16a receives the management information as well as the cooperation information, the management information reception unit 16a extracts “delegation source ICS name, delegation source user, delegation source cooperation destination information” from the cooperation information, and stores “delegation source ICS name, delegation source user, delegation source cooperation destination information” to the cooperation information table 13b.

The backup resource reserving unit 16b is a processing unit for reserving the resource for backing up the data of the delegation source. For example, the backup resource reserving unit 16b reserves, in the cloud system of its own, the storage resource storing the data of the user of the delegation source and the minimum network resource for receiving the data, on the basis of the management information received by the management information reception unit 16a.

For example, a case where the “delegation source ICS name” as illustrated in FIG. 4 is the “ICS5User05” of the “ICS 5” will be explained. In the case of FIG. 4, “the type of circuit is VPN, and the band width is 100 Mbps, the storage capacity is 5 GB, the CPU resource is 8 GHz, 8 cores” is stored as the failure reference resource information. On this information, the backup resource reserving unit 16b obtains information indicating that the user of the delegation source is using 5 GB as the storage region of the data. For this reason, the backup resource reserving unit 16b executes reserving process for reserving the resource storing 5 GB which is the amount of data used by the user “ICS5User05” and reserving process for reserving the network resource capable of transmitting/receiving 5 GB.

For example, the backup resource reserving unit 16b transmits the request for reserving the capacity of 5 GB to the storage management server 20, and reserves the region capable of storing 5 GB in the cloud system 1. The backup resource reserving unit 16b transmits the request for reserving the minimum band width capable of transmitting and receiving 5 GB of data to the network management server 30, and reserves the minimum band width. Then, the backup resource reserving unit 16b outputs information indicating that the region and the band width is reserved for backing up the data to the backup processing unit 16c. For example, the storage management server 20 newly reserves 5 GB region in the DB server, and the network management server 30 reserves the band width of 10 Mbps for the DB server.

The backup processing unit 16c is a processing unit that receives data from the delegation source using the network resource reserved by the backup resource reserving unit 16b, and stores the data to the storage resource reserved by the backup resource reserving unit 16b. Hereinafter, this will be explained using the example used in the explanation about the backup resource reserving unit 16b.

In this case, the backup processing unit 16c receives the data from the “ICS 5”, using the circuit of 10 Mbps reserved by the network management server 30. Then, the backup processing unit 16c stores the received data to the region of 5 GB reserved by the storage management server 20. The backup processing unit 16c may perform backup with a regular interval, or the backup may be executed based on an instruction given by a user and the like.

The switch detection unit 16d is a processing unit that transmits instruction of system switching to the switch control unit 16e when occurrence system switching or recovery is detected. For example, when the switch detection unit 16d is notified that the request of system switching is received from the request analysis unit 14a, the switch detection unit 16d detects the occurrence system switching or recovery when “NG” is stored to “periodical acquisition result” of the management information table 13a. The switch detection unit 16d detects that failure occurs in the cloud system of the main system with, for example, SNMP (Simple Network Management Protocol) and monitoring software, the switch detection unit 16d detects the occurrence system switching or recovery.

The switch control unit 16e is a processing unit that executes system switching and recovery. For example, when the cloud system 1 is allowed to be used by the user of the cloud system of the delegation source, the switch control unit 16e reserves, in the cloud system 2, the network resource and the processor resource managed by the ICS of the cloud system of the delegation source. Then, the switch control unit 16e notifies the user that the system switching is executed.

An example where the “delegation source ICS name” as illustrated in FIG. 4 reserves the resource of “ICS5User05” of “ICS 5” will be explained. In the case of FIG. 4, “the type of circuit is VPN, and the band width is 100 Mbps, the storage capacity is 5 GB, the CPU resource is 8 GHz, 8 cores” is stored as the failure reference resource information. On the basis of this information, the switch control unit 16e recognizes that the user of the delegation source is using VPN of 100 Mbps and using eight 8 GHz CPUs.

Then, the switch control unit 16e transmits the request for reserving eight 8 GHz CPUs to the storage management server 20, and reserves eight 8 GHz CPUs in the cloud system 1. Likewise, the switch control unit 16e transmits a setting request for making 100 Mbps VPN available to the network management server 30, and reserves 100 Mbps VPN in the cloud system 1. The network management server 30 may free the band width of 10 Mbps already reserved for the data backup, and may reserve VPN of 100 Mbps including this 10 Mbps.

The switch control unit 16e obtains, e.g., address information of the user whose “delegation source ICS name” corresponds to “ICS5User05” of “ICS 5” from the management information table 13a. Then, the switch control unit 16e notifies the IP address of the server which newly provides the resource to the user to the destination which is the address information of the user obtained. As a result, even when the system is switched, the user can use continuously the services used with the main system.

Configuration Storage Management Server

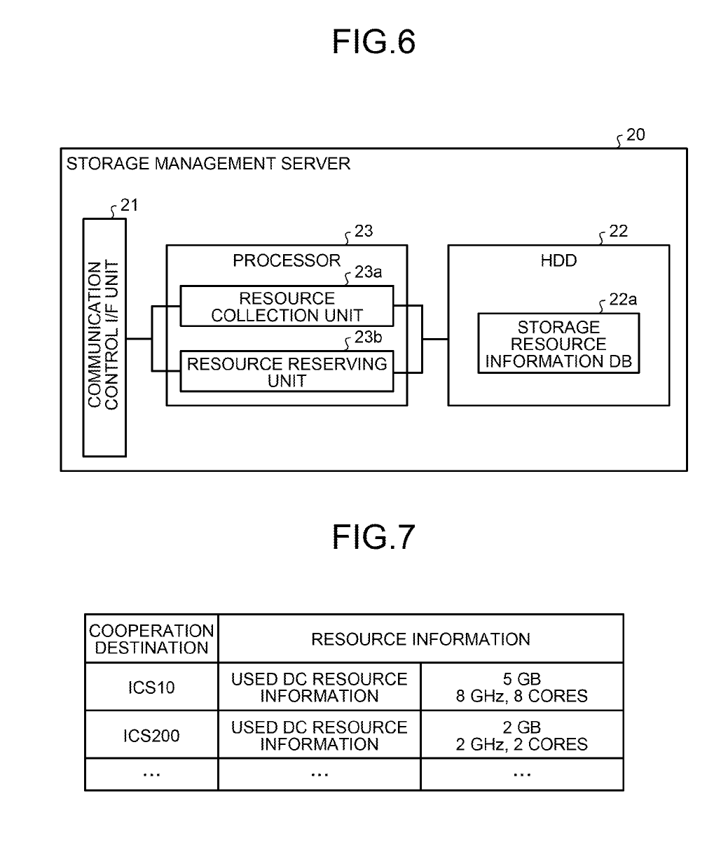

FIG. 6 is a functional block diagram illustrating a configuration of a storage management server according to the first embodiment. As illustrated in FIG. 6, the storage management server 20 includes a communication control I/F unit 21, an HDD 22, and a processor 23.

The communication control I/F unit 21 is an interface for controlling communication with another apparatus and system. For example, the communication control I/F unit 21 executes transmission/reception of various kinds of information with the cloud cooperation server 10, the network management server 30, and various kinds of server in another cloud system. For example, the communication control I/F unit 21 receives the resource reserving request from the cloud cooperation server 10 in the cloud system, and transmits the reserving result of the resource to the cloud cooperation server 10.

The HDD 22 stores programs and the like executed by the processor 23, and includes a work region and the like temporarily storing data and the like when each processing unit of the processor 23 executes processing. This HDD 22 includes a storage resource information DB 22a.

The storage resource information DB 22a stores the storage resource and processor resource used by the user in the cloud system 1, managed by the storage management server 20. FIG. 7 is a figure illustrating an example of information stored in a storage resource information DB. As illustrated in FIG. 7, the storage resource information DB 22a stores “connection destination, resource information” in association with each other.

The “connection destination” stored here is an identifier of ICS including the storage management server 20, or an identifier of ICS collecting information managed by the storage management server 20. The “resource information” is the storage resource or processor resource being used. More specifically, the storage resource information DB 22a stores the resource information which each server in the same cloud system provides to the ICS and the resource information provided to a server of a cloud system different from the storage management server 20.

In the case of FIG. 7, this indicates that the storage resource of 5 GB and the processor resource of eight CPUs of 8 GHz are provided in the entire server in the same cloud system 1 as the ICS 10. This indicates that the storage resource of 2 GB and the processor resource of two CPUs of 2 GHz are provided to the cloud system having a ICS 200.

The processor 23 is an electronic circuit such as a CPU performing control of the entire storage management server 20, and includes a resource collection unit 23a and a resource reserving unit 23b. The resource collection unit 23a collects the resource information used at this moment from each server in the same cloud system as the storage management server 20, and stores the information to the storage resource information DB 22a.

For example, the resource collection unit 23a stores the value of a summation of the amount of data used by each server, as the storage resource used by the user, to the storage resource information DB 22a. The resource collection unit 23a obtains the performance and the number of cores of the CPU of each server, and stores the average performance and the summation of the number of cores, as the processor resource used by the user, to the storage resource information DB 22a. The resource collection unit 23a may execute collection of the resource with a regular interval, or may execute collection thereof when the resource of the server changes, or may execute collection thereof with any given timing.

The resource reserving unit 23b is a processing unit for reserving the storage resource and processor resource in the own cloud system in accordance with the request from the ICS. For example, when the resource reserving unit 23b receives the reserving request of the storage resource for backup from the ICS 10, the resource reserving unit 23b looks up the vacancy of the resource with each server in the cloud system 1 to which the apparatus in question belongs. Then, the resource reserving unit 23b determines whether the resource request by the ICS 10 can be reserved or not, and responds the result to the ICS. Thereafter, the resource reserving unit 23b reserves the storage resource for data backup to the cloud system 1 in accordance with instruction given by the ICS 10.

When the resource reserving unit 23b receives the reserving request of the processor resource from the ICS 10 during system switching, the resource reserving unit 23b looks up, e.g., the number of CPUs that can be allocated to each server in the cloud system 1 to which the apparatus in question belongs. Then, the resource reserving unit 23b determines whether the resource request by the ICS 10 can be reserved or not, and responds the result to the ICS 10. Thereafter, the resource reserving unit 23b allocates the CPU for the requested processor resource as the available CPU in accordance with instruction given by the ICS 10. When the resource reserving unit 23b reserves new resource, the resource reserving unit 23b updates information in the storage resource information DB 22a.

Configuration of Network Management Server

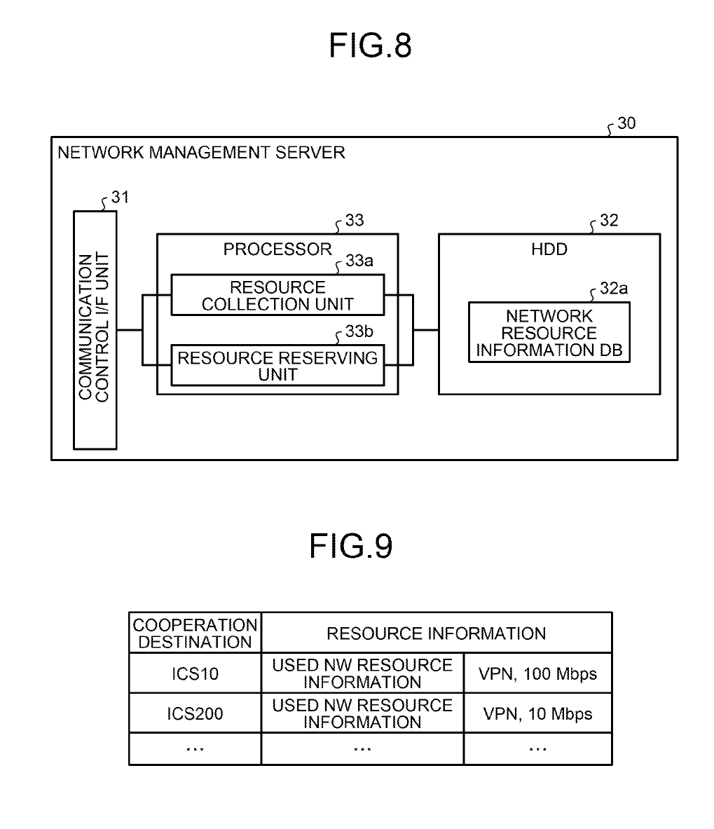

FIG. 8 is a functional block diagram illustrating a configuration of a network management server according to the first embodiment. As illustrated in FIG. 8, the network management server 30 includes a communication control I/F unit 31, an HDD 32, and a processor 33.

The communication control I/F unit 31 is an interface for controlling communication with another apparatus and system. For example, the communication control I/F unit 31 executes transmission/reception of various kinds of information with the cloud cooperation server 10, the storage management server 20, and various kinds of server in the cloud system 1. For example, the communication control I/F unit 31 receives the resource reserving request from the cloud cooperation server 10 in the cloud system, and transmits the reserving result of the resource to the cloud cooperation server 10.

The HDD 32 stores programs and the like executed by the processor 33, and includes a work region and the like temporarily storing data and the like when each processing unit of the processor 33 executes processing. This HDD 32 includes a network resource information DB 32a.

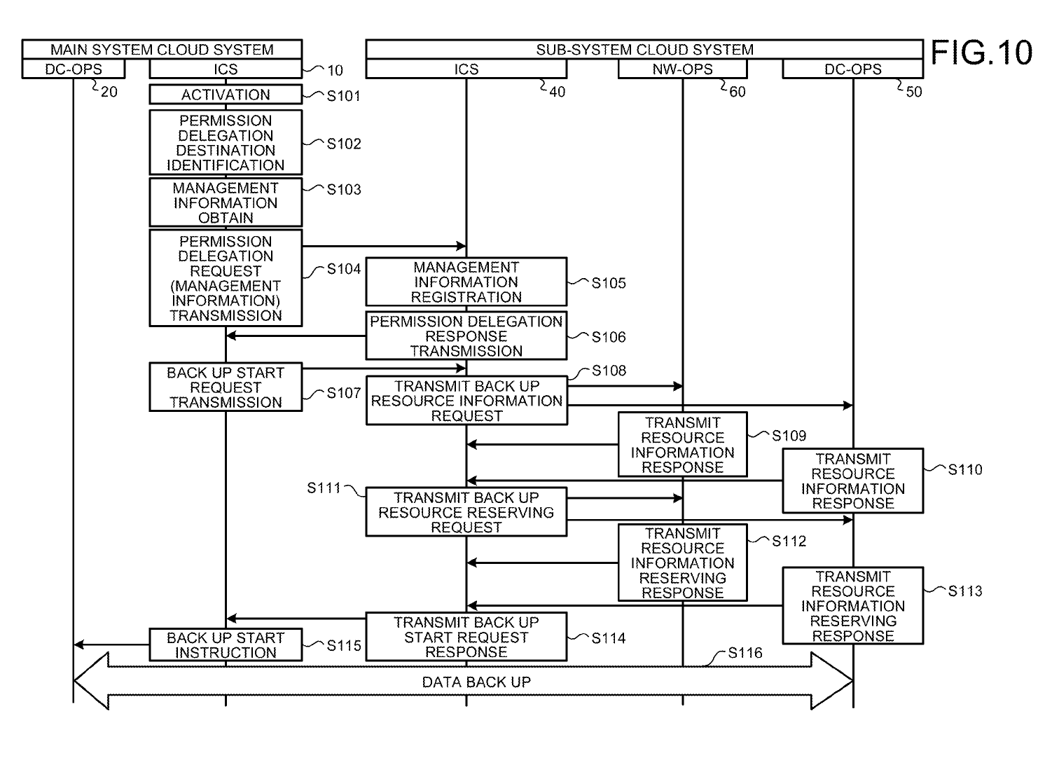

The network resource information DB 32a stores the network resource used by the user in the cloud system 1, managed by the network management server 30. FIG. 9 is a figure illustrating an example of information stored in the network resource information DB. As illustrated in FIG. 9, the network resource information DB 32a stores “connection destination, resource information” in association with each other.

The “connection destination” stored here is an identifier of ICS including the network management server 30, or an identifier of ICS collecting information managed by the network management server 30. The “resource information” is the network resource being used. More specifically, the network management server 30 stores the resource information which each server in the same cloud system 1 provides to the ICS 10 and the resource information provided to a server of a cloud system different from the cloud to which the storage management server 20 belongs.

In the case of FIG. 9, this indicates that, in the same cloud system 1 as the ICS 10, VPN of 100 Mbps is allocated to the user. This indicates that VPN of 10 Mbps is provided to the user of the cloud system having the ICS 200.

The processor 33 is an electronic circuit such as a CPU performing control of the entire network management server 30, and includes a resource collection unit 33a and a resource reserving unit 33b. The resource collection unit 33a collects the band width and circuit information about the network currently used in the same cloud system as the network management server 30, and stores the band width and circuit information to the network resource information DB 32a. The resource collection unit 33a may execute collection of the resource with a regular interval, or may execute collection thereof with any given timing.

The resource reserving unit 33b is a processing unit for reserving the network resource in the cloud system 1 in accordance with the request from the ICS 10. For example, when the resource reserving unit 33b receives the reserving request of the network resource for backup from the ICS 10, the resource reserving unit 33b determines whether the resource requested from the ICS 10 can be reserved or not, and responses the result to the ICS 10. Thereafter, the resource reserving unit 33b allocates the network resource for data backup in accordance with instruction given by the ICS 10.

When the resource reserving unit 33b receives the reserving request of the network resource from the ICS 10 during system switching, the resource reserving unit 33b obtains the band width used at this moment and the band width available in the entire cloud system 1. Then, the resource reserving unit 33b determines whether the resource request by the ICS 10 can be reserved or not, and responds the result to the ICS 10. Thereafter, the resource reserving unit 33b allocates the requested network resource in accordance with instruction given by the ICS 10. When the resource reserving unit 33b reserves new resource, the resource reserving unit 33b updates information in the network resource information DB 32a.

Flow of Processing

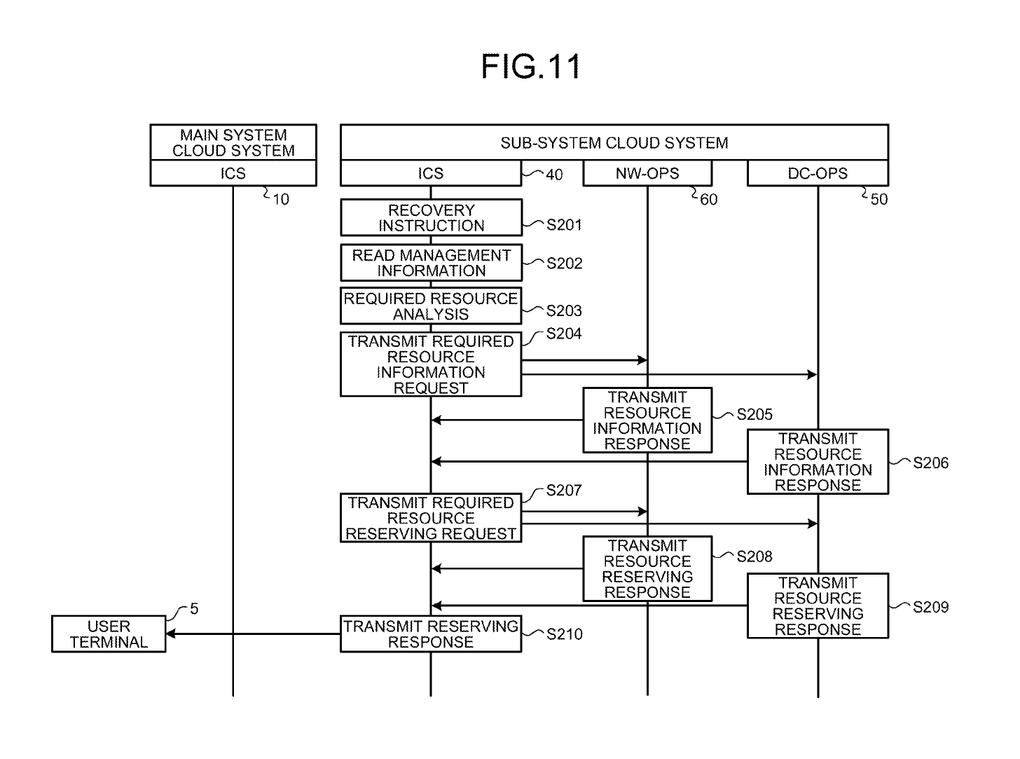

Subsequently, a flow of processing according to the first embodiment will be explained with reference to FIGS. 10 and 11. FIGS. 10 and 11 are sequence diagrams illustrating a flow of processing according to the first embodiment. In this case, the cloud system 1 as illustrated in FIG. 1 serves as the main system, and the cloud system 2 serves as the sub-system.

As illustrated in FIG. 10, when the ICS 10 of the main system cloud system is activated (Step S101), the ICS 10 identifies the permission delegation destination on the basis of the contents designated by the administrator and users (Step S102). In this case, suppose that it is identified as the ICS 40. Then, the management information transmission unit 15a of the ICS 10 obtains the management information from the resource information DB 12a (Step S103), and transmits the permission delegation request as well as the management information to the ICS 40 (Step S104).

When the management information reception unit 16a of the ICS 40 of the sub-system cloud system 2 receives the management information as well as the permission delegation request from the ICS 10, the management information reception unit 16a registers the received management information to the management information DB (Step S105). Then, the management information reception unit 16a of the ICS 40 transmits the permission delegation response to the ICS 10 as a response to the permission delegation request (Step S106).

The permission delegation request unit 15 of the ICS 10 having received the permission delegation response transmits a backup start request to the ICS 40 (Step S107). The backup resource reserving unit 16b of the ICS 40 having received the backup start request transmits, to the NW-OPS 60 and the DC-OPS 50, a request for checking whether the backup resource information identified based on the management information can be reserved or not (Step S108). At this occasion, the backup resource reserving unit 16b of the ICS 40 transmits, as the backup resource information, information indicating as to whether the capacity capable of storing the data can be reserved or not to the DC-OPS 50. The backup resource reserving unit 16b of the ICS 40 checks the NW-OPS 60 as to whether the minimum band width capable of receiving the data can be reserved or not.

The resource reserving unit 33b of the NW-OPS 60 having received the request transmits a response, indicating whether the minimum band width used for the data backup can be reserved or not, to the ICS 40, in view of the band width currently used and the band width available in the entire cloud system (Step S109). Likewise, the resource reserving unit 23b of the DC-OPS 50 obtains the storage capacity available from each server in the cloud system, and transmits a response, indicating whether the region used for the data backup can be reserved or not, to the ICS 40 (Step S110). In this case, suppose that both transmit responses indicating that they can be reserved.

The backup resource reserving unit 16b of the ICS 40 having received the responses indicating that they can be reserved from both of the management servers transmits the reserving request of the backup resource to the NW-OPS 60 and the DC-OPS 50 (Step S111). The resource reserving unit 33b of the NW-OPS 60 sets a band width that allows backup data to be transmitted and received between the main system cloud system 1 and the sub-system cloud system 2, and transmits the reserving response of the resource information to the ICS 40 (Step S112). Likewise, the resource reserving unit 23b of the DC-OPS 50 reserves the region used for the data backup in each server in the cloud system, and transmits the reserving response of the resource information to the ICS 40 (Step S113).

The backup resource reserving unit 16b of the ICS 40 having received the resource reserving response from both management servers transmits the response, in reply to the backup start request having received in Step S107, to the ICS 10 (Step S114). The processor of the ICS 10 having received the response transmits the backup start instructions to the DC-OPS 20 (Step S115).

By doing so, the data backup is started between the sub-system cloud system 2 and the DC-OPS 20 of the main system cloud system 1 (Step S116). More specifically, the backup processing unit 16c of the ICS 40 receives data from the DC-OPS 20 using the minimum band width allocated to the data backup, and stores the data to the allocated region for the data backup.

Hereinafter, the sequence diagram in FIG. 11 will be referred to. Thereafter, the switch detection unit 16d of the ICS 40 of the sub-system cloud system 2 detects recovery instruction according to failure and the like of the main system cloud system 1 (Step S201). Then, the switch control unit 16e of the ICS 40 reads the management information from the management information table 13a of the management information DB 13 (Step S202). Then, the switch control unit 16e of the ICS 40 refers to the failure reference resource information, analyzes the resource information used by the user with the main system cloud system 1, and identifies the resource information used for the recovery (Step S203).

The switch control unit 16e of the ICS 40 transmits the reserving request of the resource information used for the recovery to each of the NW-OPS 60 and the DC-OPS 50 (Step S204). The resource reserving unit 33b of the NW-OPS 60 having received the request transmits a response, indicating whether the band width used for the used recovery can be reserved or not, to the ICS 40, in view of the band width currently used and the band width available in the entire cloud system (Step S205). Likewise, the resource reserving unit 23b of the DC-OPS 50 obtains the number of processors available from each server in the cloud system, and transmits a response, indicating whether the processor used for the requested recovery can be reserved or not, to the ICS 40 (Step S206). In this case, suppose that both transmit responses indicating that they can be reserved.

The switch control unit 16e of the ICS 40 having received responses indicating that they can be reserved from both of the management servers transmits reserving request of the resource used for the recovery to the NW-OPS 60 and the DC-OPS 50 (Step S207). The resource reserving unit 33b of the NW-OPS 60 sets a requested band width between the main system cloud system 1 and the sub-system cloud system 2, and transmits the reserving response of the used resource to the ICS 40 (Step S208). Likewise, the resource reserving unit 23b of the DC-OPS 50 reserves the requested CPU in each server in the cloud system 2, and transmits the reserving response of the used resource to the ICS 40 (Step S209).

Thereafter, the switch control unit 16e of the ICS 40 having received the resource reserving responses from both of the management servers transmits the reserving response to the user terminal 5 (Step S210). The destination of the user terminal 5 is stored in, for example, the management information table 13a. The reserving response transmitted here includes, for example, information about application and address information about the server of the cloud system 2 that is going to be used by the user of the cloud system 1.

Effects of First Embodiment

The cloud system according to the first embodiment can change the backup destination freely by providing the cloud cooperation server. The amount of resource and the quality of the resource used for the backup can be designated with the management information (ConfigList) transmitted when the user carries out the permission delegation. When the management information is not transmitted to the ICS of the identification, but is notified to multiple ICSes, then each ICS analyzes the user request from the management information, and returns the resource information back to the source ICS as the management information, thus satisfying the request. In normal state, the sub-system is operated only for the backup of data with the minimum used resource, and is caused to function as the main system during failure upon acquisition of the management information based on the permission delegation, so that the reduction of the cost and the ability to continue the services during occurrence of failure can be achieved at the same time.

### [b] Second Embodiment

In the first embodiment, an example where the resource of the main system can be reserved by the sub-system, but in the second embodiment, a case where the main system resource cannot be reserved with the sub-system will be explained.

Entire Configuration

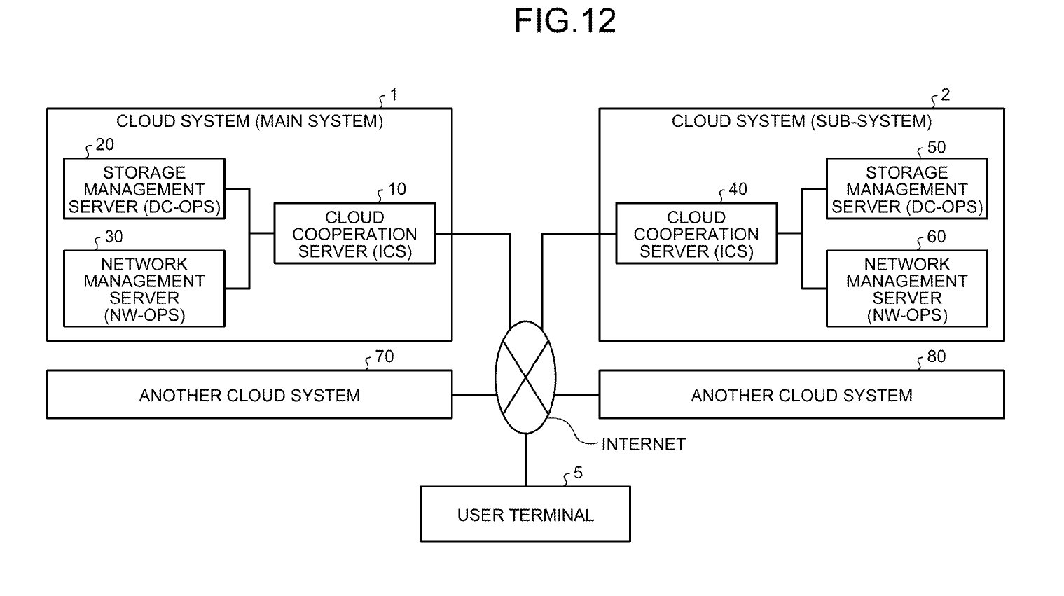

FIG. 12 is a figure illustrating an entire configuration example of a system according to a second embodiment. As illustrated in FIG. 12, this system includes a cloud system (main system) 1, a cloud system (sub-system) 2, another cloud system 70, another cloud system 80, and a user terminal 5. The apparatus configuration provided in each cloud system is the same as FIG. 1, and detailed description thereabout is omitted.

In such system configuration, the following example will be explained: the permission is delegated from the cloud system (main system) 1 to the cloud system (sub-system) 2, and the cloud system (sub-system) 2 reserves the resource used by the cloud system (main system) 1.

Flow of Data Backup

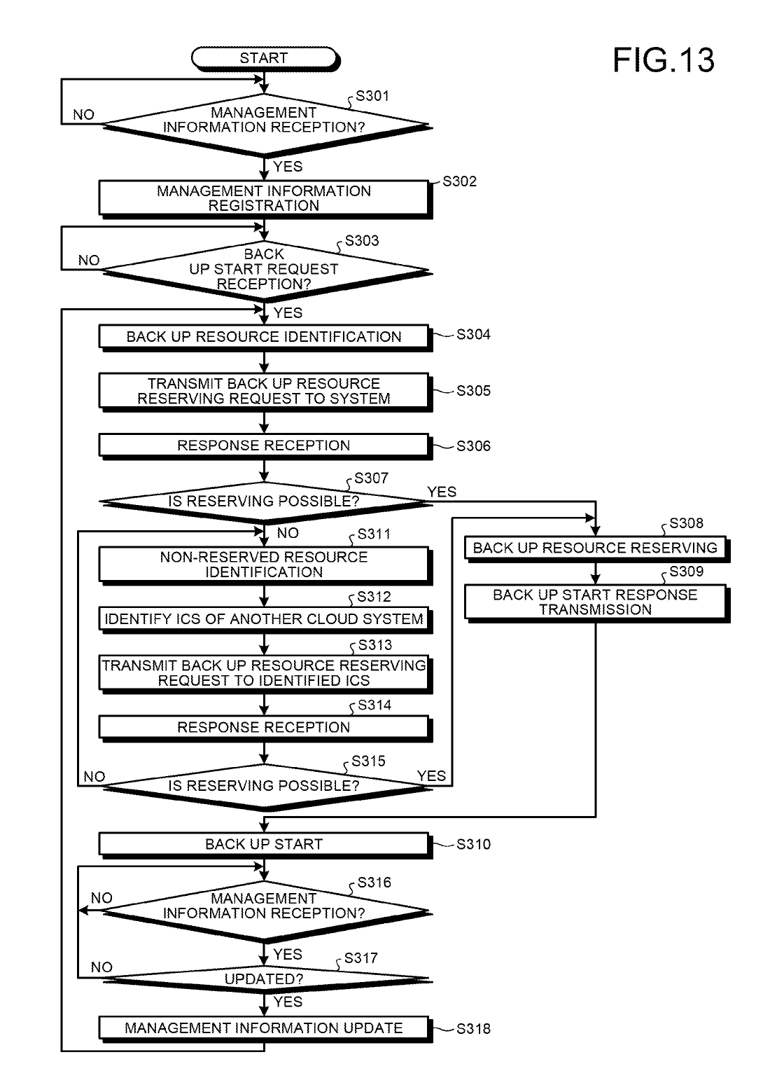

FIG. 13 is a flowchart illustrating data backup executed by a cloud system (sub-system) according to the second embodiment. As illustrated in FIG. 13, when the management information reception unit 16a of the ICS 40 of the cloud system 2 receives the management information from the cloud system 1 (Yes in Step S301), the management information reception unit 16a registers the received management information to the management information table 13a of the management information DB 13 (Step S302).

Thereafter, when the backup resource reserving unit 16b of the ICS 40 receives the backup start request from the cloud system 1 (Yes in Step S303), the backup resource reserving unit 16b identifies the resource of the data backup (Step S304).

Then, the backup resource reserving unit 16b transmits the resource reserving request of the backup identified to each of the DC-OPS 50 and the NW-OPS 60 in the cloud system 2 (Step S305). Subsequently, the backup resource reserving unit 16b receives a response indicating whether the resource can be reserved or not from each of the DC-OPS 50 and the NW-OPS 60 (Step S306).

When the backup resource reserving unit 16b determines that the resource can be reserved on the basis of the response (Yes in Step S307), the backup resource reserving unit 16b causes each of the DC-OPS 50 and the NW-OPS 60 to reserve the backup resource (Step S308). Then, the backup resource reserving unit 16b transmits the backup start response to the cloud system (Step S309). Thereafter, the backup processing unit 16c uses only the resource of the data backup reserved to start the data backup of the cloud system 1 (Step S310).

On the other hand, when the backup resource reserving unit 16b determines that the resource cannot be reserved on the basis of the response received in Step S306 (No in Step S307), the non-reserved resource is identified (Step S311). For example, the backup resource reserving unit 16b receives the response as well as the resource capacity that can be reserved from each management server. Then, the backup resource reserving unit 16b calculates the difference between the amount of data identified from the management information and the capacity that can be reserved received from the DC-OPS 50, and identifies the calculated difference as the non-reserved resource. The band width can also be processed in the same manner.

Then, the backup resource reserving unit 16b identifies the ICS of the another cloud system 70 which is to be a subsequent delegation destination in accordance with the priority and the like as the delegation destination (Step S312), and transmits the reserving request of the backup resource for the non-reserved amount to the identified ICS (Step S313). As a result, the ICS of the another cloud system 70 receives the resource that can be reserved from each management server within the cloud system of its own, and identifies the resource that can be reserved, and responds to the ICS 40.

Then, the backup resource reserving unit 16b receives a response indicating whether the resource can be reserved or not from the ICS of the another cloud system 70 (Step S314).

When the backup resource reserving unit 16b determines that the resource can be reserved on the basis of the response (Yes in Step S315), the backup resource reserving unit 16b executes processing of Step S308 and subsequent steps. On the other hand, when the backup resource reserving unit 16b determines that the resource cannot be reserved on the basis of the response (No in Step S315), the backup resource reserving unit 16b executes processing of Step S311 and subsequent steps on another cloud system 80 which has the second highest priority.

After the backup starts, the management information reception unit 16a of the ICS 40 receives the management information from the CIS 10 of the delegation source (Yes in Step S316), and when the received management information is updated from the previously received management information (Yes in Step S317), then, the management information DB 13 is updated (Step S318). Then, the ICS 40 executes processing of Step S304 and subsequent steps on the basis of the updated management information.

Flow During System Switching

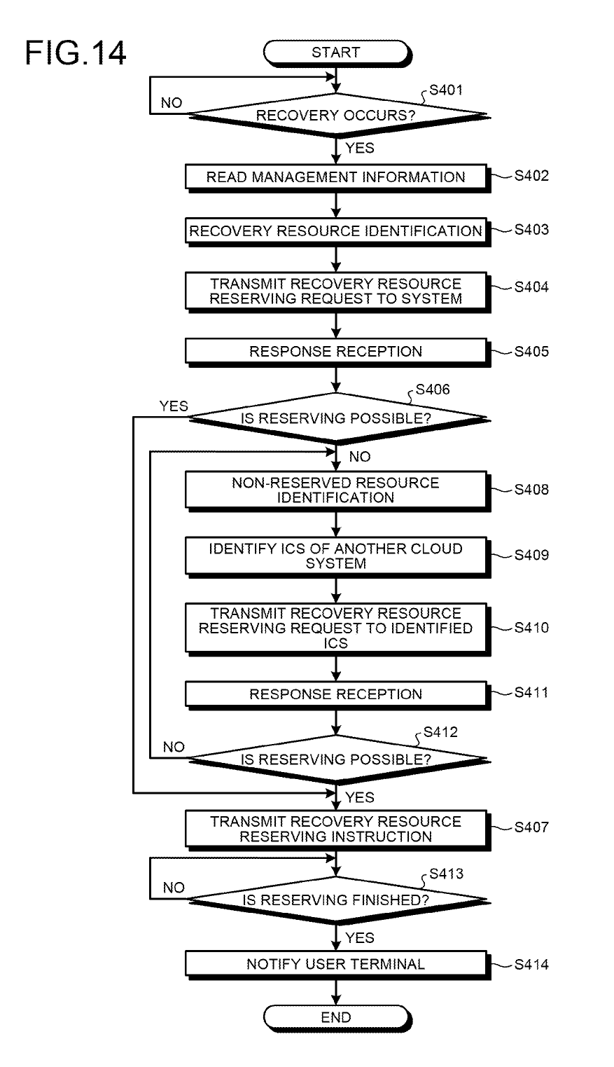

FIG. 14 is a flowchart illustrating system switching executed by a cloud system (sub-system) according to the second embodiment. As illustrated in FIG. 14, when the switch detection unit 16d of the ICS 40 of the cloud system 2 detects occurrence of recovery (Yes in Step S401), the switch control unit 16e of the cloud system 2 reads the management information from the management information table 13a (Step S402).

Subsequently, the switch control unit 16e of the cloud system 2 refers to the failure reference resource information, analyzes the resource information used by the user with the main system cloud system 1, and identifies the resource information used for the recovery (Step S403).

Then, the switch control unit 16e of the ICS 40 transmits the reserving request of the resource information used for the recovery to each of the NW-OPS 60 and the DC-OPS 50 (Step S404). Thereafter, the switch control unit 16e receives the response indicating whether the resource used for the recovery can be reserved or not from each of the DC-OPS 50 and the NW-OPS 60 (Step S405).

When the switch control unit 16e of the ICS 40 determines the resource used for the recovery can be reserved on the basis of the response (Yes in Step S406), the switch control unit 16e of the ICS 40 transmits the recovery resource reserving instruction to each of the DC-OPS 50 and the NW-OPS 60 (Step S407).

On the other hand, when the switch control unit 16e of the ICS 40 determines the resource used for the recovery cannot be reserved on the basis of the response received in Step S405 (No in Step S406), the switch control unit 16e identifies the non-reserved resource (Step S408). For example, the switch control unit 16e receives the response as well as the resource capacity that can be reserved from each management server. Then, the switch control unit 16e calculates the difference between the number of processors identified from the management information and the number of processors that can be reserved received from the DC-OPS 50, and identifies the calculated difference as the non-reserved processor resource. The band width can also be processed in the same manner.

Then, the switch control unit 16e identifies the ICS of another cloud system 70 which is a subsequent delegation destination in accordance with the priority and the like as the delegation destination (Step S409), and transmits the recovery resource reserving request for the non-reserved portion to the identified ICS (Step S410). As a result, the ICS of the another cloud system 70 receives the resource that can be reserved from each management server in the cloud system in question, identifies the resource that can be reserved, and responds to the ICS 40.

Then, the switch control unit 16e receives a response indicating whether the resource can be reserved or not from the ICS of the another cloud system 70 (Step S411). When the switch control unit 16e determines that the resource can be reserved on the basis of the response (Yes in Step S412), the switch control unit 16e executes processing of Step S407 and subsequent steps. On the other hand, when the switch control unit 16e determines that the resource cannot be reserved on the basis of the response (No in Step S412), the backup resource reserving unit 16b executes processing of Step S408 and subsequent steps on another cloud system 80 which has the second highest priority.

As described above, the switch control unit 16e having reserved the recovery resource receives a response indicating that the resource is reserved from the ICS or the management server reserving the recovery resource (Yes in Step S413), the switch control unit 16e transmits information used for the user terminal 5 (Step S414). As a result, without reminding the user of the system switching, the system switching is executed, whereby the services provided by the cloud system 1 are continued.

Effects of the Second Embodiment

According to the second embodiment, even when the sub-system to which the permission of the main system is delegated cannot reserve the resource of the main system, the resource of another cloud system can be reserved, and the services can be continued, and therefore, the reliability of the system is improved. By making use of the feature of the cloud system that does not remind the user of the resource, the main system can be recovered by reserving the resource of any cloud system connected to the Internet even if the recovery resource is not reserved the recovery resource in the sub-system.

### [c] Third Embodiment

The embodiments of the present invention have been hereinabove explained, but various different forms may be carried out in addition to the embodiments of the present invention explained above. Therefore, hereinafter different embodiments will be explained.

User Information

For example, the ICS of the sub-system receives information about a user who uses the cloud system of the main system together with the management information from the ICS of the main system. The information of the user received here is, for example, user's identifier, IP address, location, and the like. The ICS of the sub-system uses the user information to transmit notifications and the like after the system switching to the user.

Priority

For example, the main system can identify the delegation destination and the non-reserved resource reserving destination on the basis of the priority designated in advance. This priority may also be set to any priority by administrators and users, and, for example, the priority may be set in the descending order of the non-used resource.

Delegation Cancellation

For example, when the sub-system receives delegation cancellation notification from the main system, the sub-system transmits cancellation response to the request source, and deletes the management information about the main system from the management information DB. By doing so, the relationship between the delegation destination and the delegation source can be deleted.

System

All or a part of the processing explained in the present embodiment, which are performed automatically in the above explanation, may be performed manually. Alternatively, all or a part of the processing explained in the present embodiment, which are performed manually in the above explanation, may be performed automatically. In addition, information including the processing procedure, the control procedure, the specific names, various kinds of data and parameters illustrated in the drawings or in the above texts may be changed in any form except as otherwise noted.

The components of each device illustrated are functionally conceptual, and the components are not always physically configured as illustrated in the drawings. Specifically, specific forms of separation and combination of each device are not limited to those depicted in the drawings. A configuration may be such that all or some of devices are functionally or physically separated or combined in an arbitrary unit depending on various types of loads or usage. Furthermore, all or any of various processing functions performed by each device may be implemented by a CPU and the program analyzed and executed by the CPU or may be implemented as wired logic hardware.

Hardware Configuration

By the way, various kinds of processing explained in the above embodiments can be achieved when a program prepared in advance is executed by a computer system such as a personal computer and a work station. Therefore, in the explanation below, an example of computer system executing a program having the same functions as the above embodiments will be explained.

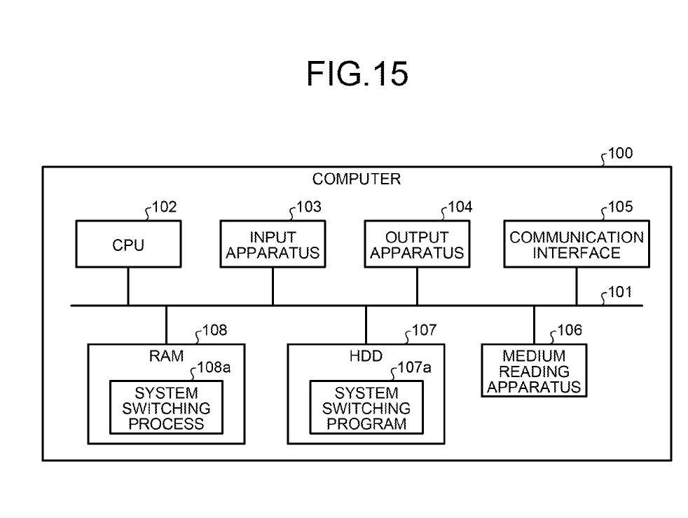

FIG. 15 is a figure illustrating an example of hardware configuration of a computer executing a system switching program. As illustrated in FIG. 15, a computer 100 includes a CPU 102, an input apparatus 103, an output apparatus 104, a communication interface 105, a medium reading apparatus 106, an HDD (Hard Disk Drive) 107, and RAM (Random Access Memory) 108. The units as illustrated in FIG. 15 are connected with each other via a bus 101.

The input apparatus 103 is a mouse and a keyboard. The output apparatus 104 is a display and the like. The communication interface 105 is an interface such as a NIC (Network Interface Card). The HDD 107 stores the DBs and the like as illustrated in FIG. 2 as well as a system switching program 107a. For example, the HDD 107 is used as an example of recording medium, but various kinds of programs may be recorded to another computer-readable recording medium such as ROM (Read Only Memory), RAM, and CD-ROM, and the computer may be caused to read the programs. The recording medium may be installed at a remote location, and the computer may obtain the programs by accessing the storage medium. At that occasion, the obtained programs may be used upon being stored to a recording medium of the computer in question.

The CPU 102 reads the system switching program 107a and extracts it to the RAM 108, thus operating system switching process 108a executing each function explained with reference to FIG. 2 and the like. More specifically, the system switching process 108a executes the same functions as the request analysis unit 14a, the management information transmission unit 15a, and the management information update unit 15b described in FIG. 2. The system switching process 108a executes the same functions as the management information reception unit 16a, the backup resource reserving unit 16b, the backup processing unit 16c, the switch detection unit 16d, and the switch control unit 16e described in FIG. 2. As described above, the computer 100 reads and executes the program, thus operating as the information processing apparatus executing the system switching method.

For example, the computer 100 reads the system switching program from the recording medium with the medium reading apparatus 106, and executes the read system switching program, so that the same functions as the above embodiments can also be achieved. The program referred to in the another embodiment is not limited to be executed by the computer 100. For example, the present invention can be applied in the same manner even when another computer or server executes the program or they cooperate with each other to execute the program.

An information processing system, a control method of an information processing system, a management apparatus, and a computer-readable recording medium according to the present invention achieve the effect of continuing services while reducing the cost of redundancy of a system.

What is claimed is:

1. An information processing system comprising a first system and a second system each having a management apparatus, wherein
the management apparatus of the first system includes:
a first memory; and
a first processor coupled to the first memory, wherein the first processor executes a process including:
collecting processor resource, storage resource and network resource used by a user with the first system; and
transmitting management information including information about each resource collected at the collecting to the second system, and
the management apparatus of the second system includes:
a second memory; and
a second processor coupled to the second memory, wherein the second processor executes a process including:
receiving the management information from the first system;
first reserving, in the second system, storage resource for storing data of the user held by the first system and a minimum network resource for receiving the data, on the basis of the management information;
receiving the data from the first system using the network resource reserved at the first reserving, and storing the data to the storage resource reserved at the first reserving; and
second reserving, in the second system, the network resource and the processor resource collected by the management apparatus of the first system, on the basis of the received management information when the user is allowed to use the second system.

2. The information processing system according to claim 1, wherein, when the minimum network resource or the collected storage resource or any combination thereof is insufficient in the second system, the first reserving includes calculating an amount of the resource that is insufficient, and reserving the amounts of the resource that cannot be reserved, in another system connected to the information processing system.

3. The information processing system according to claim 1, wherein, when the collected network resource or the collected processor resource or any combination thereof cannot be reserved in the second system, the second reserving includes calculating an amount of the resource that cannot be reserved, and reserving the amount of the resource that cannot be reserved, in another system connected to the information processing system.

4. The information processing system according to claim 1, wherein
the collecting includes collecting, with a regular interval, the processor resource, the storage resource, and the network resource from each server provided in the first system, and
the transmitting includes transmitting, to the second system with a regular interval, the management information including information about each resource of the processor resource, the storage resource, and the network resource collected at the collecting with the regular interval.

5. A control method comprising:
collecting, by a first management apparatus included in a first system, s processor resource, storage resource, and network resource used by a user with the first system;
executing, by the first management, processing of transmitting management information including information about each resource to a second system connected to the first system;
receiving, by a second management apparatus included in the second system, the management information from the first system;
reserving, by the second management apparatus, in the second system, storage resource for storing data of the user held by the first system and a minimum network resource for receiving the data, on the basis of the management information received;
receiving, by the second management apparatus, the data from the first system using the network resource reserved, and stores the data to the storage resource reserved; and
reserves, by the second management apparatus, in the second system, the network resource and the processor resource collected by the management apparatus of the first system, on the basis of the received management information when the user is allowed to use the second system.

6. A management apparatus provided in a second system connected to a first system, the management apparatus comprising:
a memory; and
a processor coupled to the memory, wherein the processor executes a process comprising:
receiving, from the first system, management information including information about each resource of processor resource, storage resource, network resource, which are used by a user with the first system;
reserving, in the second system, storage resource for storing data of the user held by the first system and a minimum network resource for receiving the data, on the basis of the management information received;
receiving the data from the first system using the network resource reserved, and storing the data to the storage resource reserved; and
reserving, in the second system, the network resource and the processor resource used by the user with the first system, on the basis of the received management information when the user is allowed to use the second system.

7. A computer-readable recording medium having stored therein an execution control program that causes a computer included in a second system connected to a first system to execute a process comprising:
receiving, from the first system, management information including information about each resource of processor resource, storage resource, network resource, which are used by a user with the first system;
reserving, in the second system, storage resource for storing data of the user held by the first system and a minimum network resource for receiving the data, on the basis of the management information received;
receiving the data from the first system using the network resource reserved, and stores the data to the storage resource reserved; and
reserving, in the second system, the network resource and the processor resource used by the user with the first system, on the basis of the received management information when the user is allowed to use the second system.
